(19) United States
(12) Patent Application Publication
(10) Pub. No.: US 2014/0244319 A1
(43) Pub. Date: Aug. 28, 2014

(54) SYSTEM AND METHOD FOR STORING AND FINDING ACTIVITIES

(71) Applicant: MIPINS LTD, London (GB)

(72) Inventors: Anthony Franklin, London (GB); Paul Franklin, London (GB)

(21) Appl. No.: 13/781,064

(22) Filed: Feb. 28, 2013

(51) Int. Cl. G06Q 10/02

(52) U.S. Cl. CPC G06Q 10/02
USPC 705/5; 707/722

(57) ABSTRACT

A method for finding and reserving activities, the method comprises receiving, at a search client, search criteria that comprise a search description, a search location and a search time period; searching, by a search tool, for activities stored in an activity repository based on the search criteria, wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results; and making, in the event that the selected activity is open for reservation, a reservation for the selected activity.

### FIELD

The present disclosure relates to a system and method for storing and finding activities and is particularly relevant to, but not limited to, storing and finding sport and/or health activities.

### BACKGROUND

Systems can be provided where a user can search for gym classes provided by a sport center. However, such in such systems, the user has to contact the sport center directly, using a telephone or website and can only search for the gym classes of this sport center. The user is therefore limited in his search and is left unable to compare classes across a variety of sport centers.

Moreover, such systems work on the pre-requisite that the user is already aware of the sport centers in the desired area. Therefore, if the user is for example not aware of a sport center or a gym teacher practicing in the desired area, he will not be able to accurately find the relevant gym classes in his area.

Other systems can be provided which can list gym classes in an area. However, such systems merely provide a list and the user has to book any class directly with the sport center, for example by telephoning or going to the sport center or by using the sport center's website, if any. This is a substantial barrier for users to transform the finding of a class of interest into a successful sale and booking for said class.

The problems mentioned above are not limited to gym classes but also apply to other activities such as sport and/or health related activities or other types of activities.

As a result of the problems above, users trying to find a desired activity will generally face several barriers, each of the barrier significantly reducing the chances of converting the search into a sale. Additionally, for sports and/or health related activities, this in turn reduces the general well-being of the population and it would be desirable to make access to such activities easier and more user-friendly.

The present disclosure is motivated by improving existing systems in view of at least the limitations discussed above.

### SUMMARY

Aspects and embodiments are discussed in the appended claims.

According to a first aspect of the present disclosure, there is provided a method for finding and reserving activities. The method comprises receiving, at a search client, search criteria wherein the search criteria comprise a search description, a search location and a search time period; providing the search criteria to a search tool; searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results; and making, in the event that the selected activity is open for reservation, a reservation for the selected activity.

The making a reservation may comprise providing, from the search client to an activity manager, an activity reservation request for the activity selected by the selection input. Optionally, the making a reservation may further comprise receiving, at the search client, an activity reservation message confirming that a reservation for the selected activity has been made.

The method may comprise providing, from a first activity manager, at least a first activity to the activity repository; providing, from a second activity manager, at least a second activity to the activity repository; and storing, at the activity repository, the at least first and second activities.

The plurality of activity managers comprises a sport center, a sport club or a healthcare provider. The plurality of activities may comprise sport and/or health related activities.

A time period may comprise at least one of a date, a time range, a starting time, a duration, an ending time and a repetition frequency, wherein a repetition frequency can optionally be at least one of a daily, weekly, bimonthly, monthly, or yearly frequency.

Searching for activities matching the input search criteria may comprise searching based on an exact, approximate and/or fuzzy search algorithm.

Making a reservation for the selected activity may comprise storing selection information, by a reporting unit, wherein the selection information identifies the selected activity and a corresponding user. Additionally, the method may further comprise communicating activity attendance information from an activity manager and to the reporting unit, wherein the attendance information is for the selected activity and the corresponding user; and building, using the reporting unit, an attendance report for the corresponding user, the attendance report comprising activity attendance information for selected activities for said corresponding user. For example, the building of said attendance report may comprise building the attendance report upon receipt of an attendance report request from an attendance supervisor and/or upon receipt of the activity attendance information.

According to another aspect of the present disclosure, there is provided a method for finding and reserving activities, the method comprising receiving, at a search client, search criteria wherein the search criteria comprise a search description, a search location and a search time period; providing the search criteria to a search tool; searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results. The method comprises, in the event that the selected activity is open for reservation, making a reservation for the selected activity, making a reservation for the selected activity comprising storing selection information, by a reporting unit, wherein the selection information identifies the selected activity and a corresponding user communicating activity attendance information from an activity manager and to the reporting unit, wherein the attendance information is for the selected activity and the corresponding user; and building, using the reporting unit, an attendance report for the corresponding user, the attendance report comprising activity attendance information for selected activities for said corresponding user.

According to an aspect of the present disclosure, there is provided a system for finding and reserving activities, the system comprising an activity repository, a search tool and a search client. The activity repository comprises activity storage which stores activities provided by a plurality of activity managers, wherein an activity comprises an activity title, an activity location, and an activity time period, and activity storage logic arranged to manage operations on the activity storage. The search tool comprises a search logic arranged to access the activity repository and to search for activities stored in the activity repository based on search criteria and wherein said search criteria comprise a search description, a search location and a search time period. The search client comprises a search client logic, and an input/output manager arranged to receive inputs from a user of the search client and to provide outputs to a user of the search client. The search client logic is arranged, upon identification that search criteria have been received via the input/output manager, to retrieve search results obtained, using the search tool, for said search criteria; output said search results using the input/output manager; receive selection input selecting an activity of the search results via the input/output manager; and make, in the event that the selected activity is open for reservation, a reservation for the selected activity.

According to yet another aspect of the present disclosure, there is provided a search client for finding and reserving activities, the search client comprising a search client logic, and an input/output manager arranged to receive inputs from a user of the search client and to provide outputs to a user of the search client. The search client logic is arranged, upon identification that search criteria for searching for an activity have been received via the input/output manager, to provide the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period; retrieve search results obtained, using the search tool, for said search criteria; output said search results using the input/output manager; receive, via the input/output manager, selection input selecting an activity of the search results; and make, in the event that the selected activity is open for reservation, a reservation for the selected activity.

The search client logic being arranged to make a reservation may comprise the search client logic being arranged to provide, to an activity manager, an activity reservation request for the activity selected by the selection input. Optionally, the search client logic being arranged to make a reservation may further comprise the search client logic being arranged to receive an activity reservation message confirming that a reservation for the selected activity has been made.

The plurality of activity managers may comprise a sport center, a sport club or a healthcare provider. The plurality of activities may comprise sport and/or health related activities.

According to an aspect of the present disclosure, there is provided a computer program product stored on a non-transitory computer-readable medium, comprising instructions for causing a computer to execute the steps of, upon identification that search criteria for searching for an activity have been received providing the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period; retrieving search results obtained, using a search tool, for said search criteria; outputting said search results using the input/output manager; receiving, via the input/output manager, selection input selecting an activity of the search results; and making, in the event that the selected activity is open for reservation, a reservation for the selected activity.

According to another aspect, there is provided an infrastructure for storing activities to be searched and reserved, the infrastructure comprising an activity repository and a search tool. The activity repository comprises activity storage which stores activities provided by a plurality of activity managers, wherein an activity comprises an activity title, an activity location, and an activity time period, and activity storage logic arranged to manage operations on the activity storage. The search tool comprises a search logic arranged to access the activity repository and to search for activities stored in the activity repository based on search criteria received from a search client, wherein said search criteria comprise a search description, a search location and a search time period and wherein the search tool returns search results obtained for said search criteria for the search client to provide to said user.

The plurality of activity managers may comprise a sport center, a sport club or a healthcare provider. The plurality of activities may comprise sport and/or health related activities.

The search logic may be arranged to search for activities matching the input search criteria based on an exact, approximate and/or fuzzy search algorithm.

The infrastructure may further comprise a reporting unit, wherein the reporting unit is arranged to receive and store selection information, the selection information identifying an activity selected, using the search client, from the search results and a corresponding user. For example, the reporting unit further comprises a report building unit and is further arranged to receive, from an activity manager, activity attendance information wherein the attendance information is for the selected activity and the corresponding user; and build, using the report building unit, an attendance report for the corresponding user, the attendance report comprising activity attendance information for selected activities for said corresponding user.

According to yet another aspect of the present disclosure, there is provided a computer program product stored on a non-transitory computer-readable medium, comprising instructions for causing a computer to execute the steps of storing, at an activity repository, activities provided by a plurality of activity managers, wherein an activity comprises an activity title, an activity location, and an activity time period; and searching, using a search tool, for activities stored in the activity repository based on search criteria received from a search client, wherein said search criteria comprise a search description, a search location and a search time period and wherein the search tool returns search results obtained for said search criteria for the search client to provide to said user.

### BRIEF DESCRIPTION OF DRAWINGS

The present disclosure will now be discussed, by way of example only, with reference to the following drawings in which like reference numerals denote like elements.

FIG. 1 is an illustration of an example system in accordance with the present disclosure;

FIG. 2 is an illustration of a further example system in accordance with the present disclosure;

FIG. 3 is an illustration of another example system in accordance with the present disclosure;

FIG. 4 is an illustration of yet another example system in accordance with the present disclosure;

FIG. 5 is a flowchart illustrating an example method in accordance with the present disclosure;

FIG. 6 is a flowchart illustrating a further example method in accordance with the present disclosure;

FIG. 7 is an illustration of an example message flow in accordance with the present disclosure;

FIG. 8 is an illustration of another example message flow in accordance with the present disclosure;

FIG. 9 is an illustration of an activity repository in accordance with the present disclosure;

FIG. 10 is an illustration of an activity table in accordance with the present disclosure;

FIG. 11 is an illustration of a search tool in accordance with the present disclosure;

FIG. 12 is an illustration of a reporting unit in accordance with the present disclosure;

FIG. 13 is an illustration of an attendance information table in accordance with the present disclosure;

FIG. 14 is an illustration of an attendance report in accordance with the present disclosure; and

FIG. 15 is an illustration of a search client in accordance with the present disclosure.

While the present teachings are susceptible to various modifications and alternative forms, specific embodiments are shown by way of example in the drawings and are herein described in detail. It should be understood, however, that drawings and detailed description thereto are not intended to limit the scope to the particular form disclosed, but on the contrary, the scope is to cover all modifications, equivalents and alternatives falling within the spirit and scope of the present disclosure.

### DETAILED DESCRIPTION OF EXAMPLE EMBODIMENTS

Example embodiments in accordance with the present disclosure will now be discussed for illustrative purposes. However, it will be apparent to the skilled person that the disclosed system(s), method(s), and apparatus may be implemented using any number of techniques. The present disclosure is not limited to the illustrative implementations, drawings, and techniques illustrated below, but may be modified within the scope and spirit of the appended claims along with their full scope of equivalents.

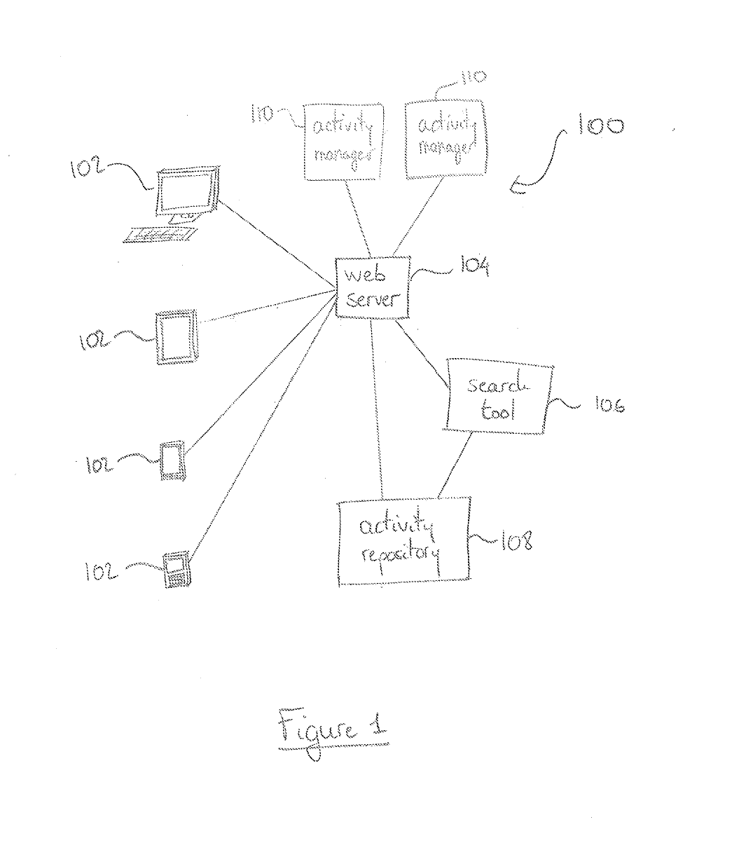

FIG. 1 is an illustration of an example system in accordance with the present disclosure. The system 100 illustrated in FIG. 1 comprises devices 102 running a search client 103 (not shown in FIG. 1), a web server 104, a search tool 106, an activity repository 108 and two or more activity managers 110. The web server 104, search tool 106 and activity repository may for example be managed by a service provider, where the service provider is for providing a platform for activity managers to provide activities to and for users to find (and possible place a reservation for) a desired activity. A device 102 may be any appropriate device, such as a computer, a tablet, a smart phone, or a phone. A search user and/or activity user may use such a device 102 to use a service provided by service provider, wherein the service provider is for storing and finding activities.

In the illustration of FIG. 1, a search user accesses a service via a web server 104 which is connected to the search tool 106 and to an activity repository 108. The web server 104 may also be used by an activity manager 110 for communicating activity to the service provider so that they can be stored in the activity repository 108 and so that they can be found by search users. An activity may comprise an activity title, an activity location and an activity time period. For example, the activity title may be “spinning class”, the activity location may be “sport center X, level 2, room A”, and the activity time period may be “every Tuesday 6 pm to 7 pm, from September to May”. The activity repository 108 stores activities provided by one or more activity managers 110.

In use, the search user inputs search criteria via the search client 103 using the device 102 when trying to find activities matching the search criteria. For example, the search user can access a web page via the device 102 and input search title, a search location and a search time period for service provider to return matching activities. For example, the search user can input “spinning” as search title, “City C” and “any time between 5 pm and 8 pm” or “in two hours”. The web server 104 can then pass the search criteria to search tool 106 for searching the activity repository 108 based on said search criteria. The search tool 106 may operate based on any appropriate search algorithm and, optionally, may also order the search results based on any suitable criteria. For example, the search may require that one or more of the search criteria match exactly the corresponding one or more entries for the activities in the activity repository; may require that one or more criteria is at least included in the corresponding one or more entries for the activities (e.g. as “spinning” is included in “spinning class”, “spinning class” would be a hit in this case); may require that a certain degree of correspondence between one or more of the search criteria and the corresponding one or more entries for the activities (e.g. “spinning lessons” may be considered to correspond sufficiently with “spinning class” to be a hit); may use any suitable matching algorithms which the skilled person will be aware of; and/or any combination of these examples.

Additionally, the search can be carried out using other parameters which are not provided by the search criteria. In some examples, a user profile may be used when identifying activities to be included in the search results either in combination with the search criteria or without the search criteria. For example, the search results corresponding to the search criteria can be complemented by additional search results based on the user profile, wherein the additional search results may not make use of the search criteria or may not make use of all of them. As an illustration, if an activity user is known to like going to the swimming pool in the evening during weekdays, a search for an activity (e.g. not related to swimming) in an evening during a weekday in a specific location may return (i) search results matching the search criteria and (ii) one or more swimming activities in or close to the specific location which may be of interest to the activity user. The balance between the search results based on the search criteria and additional search results may be determined in a static manner (e.g. the search tool 106 may be configured to always return 2 additional search results for this activity user) or dynamic manner (e.g. if the search based on the search criteria have returned no activities or a low number of activities). The balance between the search results based on the search criteria and additional search results may be determined may also be based on a user profile (e.g. if a user has been responding well to these additional suggestions) and/or may be based on whether the search user is identical to the activity user.

Moreover, the search tool 106, when it returns search results, may order the search results based on any suitable criterion or combination of criteria, such as one or more of or a combination of: distance to the desired location, correspondence score for one or more criteria, overall correspondence score, user preferences (e.g. corresponding to a search and/or activity user, as indicated by a user or as learnt through use) or activity score (e.g. review scores, commercial activities scores, etc.). In other example, the search results comprise ordering information which can be used if a search user wishes to re-order the search results. For example the search results may be ordered by default in a “price (low to high)” order but may comprise distance information such that the search user can re-order the results in a “distance” order.

Once the web server 104 receives the search results output by the search tool 106, it outputs them to the device 102, for example on a web page where the results have been ordered or pre-ordered in accordance with the output of the search tool 106. The search user can then for example select an activity of interest using the client 103 and, if the activity is open for reservation (e.g. a spinning class, a horse-riding lesson or golf tee time), the client 103 running on the device 102 can inform the web server 104 which may then cause a reservation to be place for the selected activity and for an activity user. The activity user may be the search user or may be another user. For instance, the search user using the device 102 may be a doctor in charge of a patient (activity user) and who may have decided to prescribe an activity for the patient, such as a physiotherapy activity or a gym class. The doctor (search user) can then place a reservation for an appropriate activity and for the patient (activity user). In cases where the activity can be reserved directly with the activity manager 110, the web server can cause a reservation process to be carried out with the appropriate activity manager 110 to book the activity. Once the reservation process is completed, the search client 103 may receive a reservation message (e.g. reservation confirmation or a message indicating that the reservation has failed).

Users can therefore access all activities from a variety of activity managers using a single platform and can then advantageously place a reservation for a desired activity using the same platform. Additionally, such a platform provides an attractive centralized location for users to find different activities where most of the information used or stored is not provided by the service provider itself but by users and activity managers. The service provider does not serve to control, manage or modify the content or substance of this information, as it would be the case in a sport center platform for example, by providing a more neutral platform where users and activity managers can be more comfortable with sharing information (e.g. activity or user information). As a result, by putting the users and the activity managers in contact with a user-friendly platform, the users will have a greater choice of activities and the activity manager will be able to reach a greater number of users.

It has been mentioned above that a search may optionally include criteria based upon a user profile instead of or in addition to the provided search criteria. Another example context for identifying activities based upon a user profile is where the user profile specifies some form of ability specialism or restriction. For example a person with a lifestyle affecting condition or disability may specify that condition or disability in their user profile and the search can then be carried out using that condition or disability to filter or order the search results appropriately. For example, a person who has pre-registered in their user profile as being deaf or of significantly impaired hearing could be presented with activities tailored for or specifically catering to the hearing impaired. These results could be the only results presented, could be indicated as preferred results and/or could be ordered within the results to appear first. Similarly, for a person whose user profile indicates that they are a wheelchair user the results could be tailored to activities of specific relevance to wheelchair users. The same could be used for persons with a less obvious disability such as a person recovering from a heart attack or heart surgery who needs low intensity exercise or a person with replacement joints who needs activities appropriate to the reduced range of movement inherent in some artificial joints. It is believed that by configuring the search to take account of disability information in a user profile rather than requiring a user with disabilities to have to enquire about the suitability of every potential activity to their disability, barriers to participation in activities for persons with disabilities can be reduced. It is also foreseen that user-profile based search assistance could also work for particular activity specialisms, such as a person with a keen climber wanting a certain minimum difficulty or a swimmer wanting a pool with high diving boards.

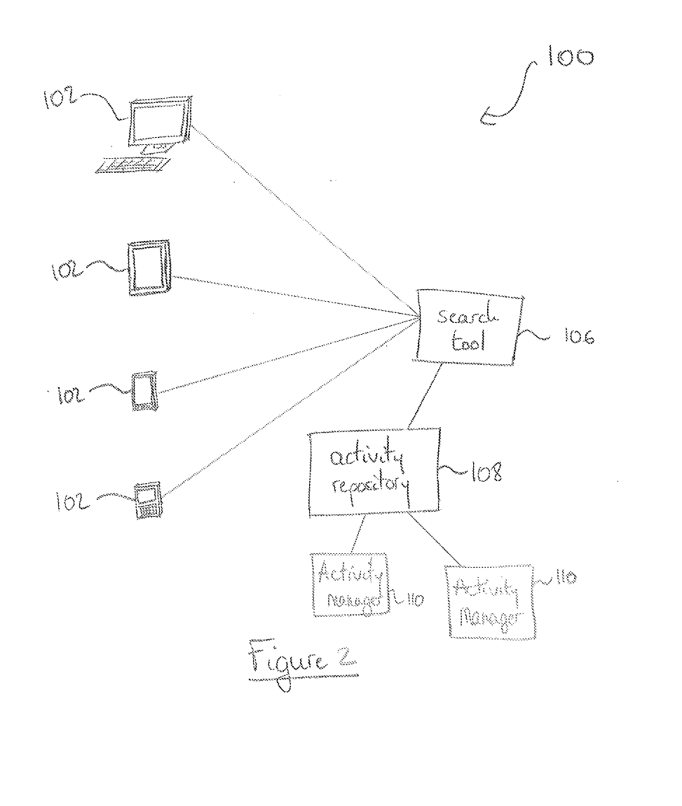

FIG. 2 is an illustration of a further example system in accordance with the present disclosure. The system 100 of FIG. 2 has some similarities with the system 100 of FIG. 1 but also some differences in how it is implemented. In the example of FIG. 2, a search client 103 may be an application installed and running on the device 102, such as an “app” on a smartphone or tablet. The search client may be arranged to connect to the search tool 106 directly or indirectly, and without addressing a web server as an intermediary node to the search tool 106. Likewise, the activity managers 110 may not require a web server to provide the activities to the activity repository 108 and may be arranged to connect to the activity repository 108 directly or indirectly, and without addressing a web server as an intermediary node to the activity repository 108. In some examples, if an activity has been selected via the search client 103 and is open for reservation, the search client 103 may be arranged to contact the activity directly or indirectly (e.g. based on information provided by the search tool 106 or activity repository 108 for the selected activity) without using a web server for this purpose. For example, an API can be provided for activity managers to process reservation queries received directly from search clients 103 or there may be provided an additional element (not shown) which can receive an indication that an activity has been selected via the search client 103 and which can then cause the activity to be reserved with the activity manager. In this manner, the search user of a search client 103 running on a device 102 may be in a position to search for and reserve activities provided by different activity managers using a single platform and a single integrated client on device 102.

In other arrangement, the system 100 may be implemented in any suitable manner, as the skilled person will be able to identify and may for example comprise any suitable combination of the implementations illustrated in FIGS. 1 and 2. For example, some search clients 103 may be arranged to use the service provided by system 100 without a web server while other search clients 103 may require a web server to use the service (e.g. web-based search clients). Likewise some of or all of the activity managers 110 may be arranged to provide activities to the activity repository 108 and/or to process reservation requests with or without a web server.

The search client 103 discussed above may be provided in any suitable form, such as a web-interface, for example as a web page accessed from a web browser; a plugin, for example which can be installed for running on a web browser or on another application; or a standalone application such as a tablet or smartphone app (wherein in some examples the standalone application may retrieve and render web pages in a non-web application).

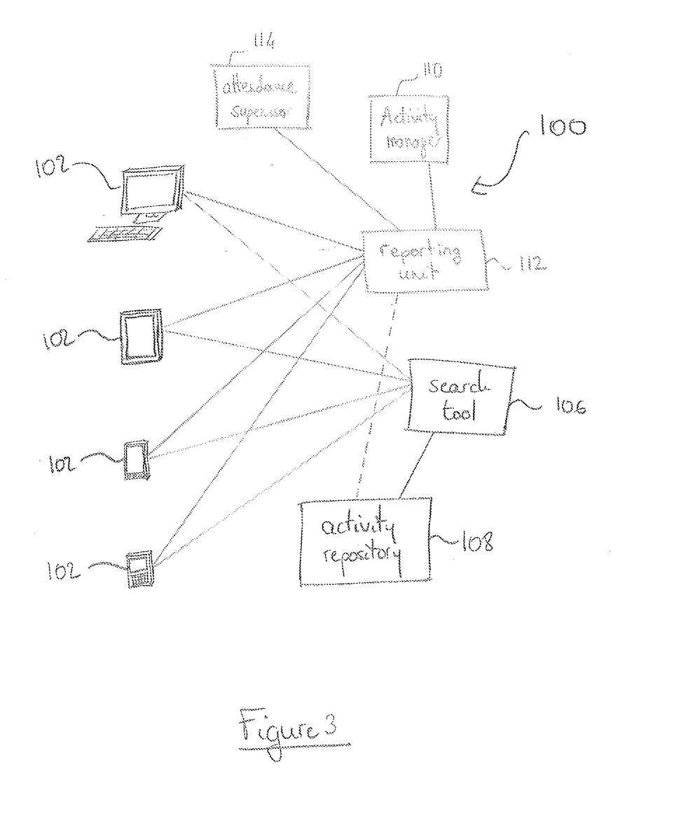

FIG. 3 is an illustration of another example system in accordance with the present disclosure. In this example, the system 100 comprises a reporting unit 112 and an attendance supervisor 114. When an activity is selected via the search client 103, the reporting unit 112 stores selection information, wherein the selection information identifies the selected activity and a corresponding activity user. As previously mentioned, said corresponding activity user may differ from the search user who selected the activity, or may be identical to the search user. Optionally, the reporting unit 112 may be arranged to access the activity repository 108, for example to retrieve information on a selected activity from the activity repository. For example, when an activity is selected, the reporting unit may initially only be forwarded an activity identification number and an activity user identification number and the reporting unit 112 may later decide to include additional details in the stored selection information, such as an identification of the activity manager for the selected activity. In this case, it may access the activity repository 108 to retrieve such additional details. Optionally, the attendance supervisor 114 may access the reporting unit 112 to retrieve reports on one or more activity users' attendance. For example, the attendance supervisor may wish to build statistics in respect of the use of the platform for placing reservation for activities or may wish to retrieve a report detailing the activities that an activity user subscribed to.

In a further embodiment, the activity manager 110 may be arranged to communicate activity attendance information for the selected activity and the corresponding activity user to the service provider, for example to the reporting unit 112. In other example, it may be sent to a different element of the service provider and said different element may be arranged to cause the activity attendance information to be forwarded to the reporting unit 112. The reporting unit 112 can build an attendance report for said corresponding activity user, wherein the attendance report comprises activity attendance information for selected activities for said corresponding activity user. For example, the attendance may include a list of all activities that the activity user has or has had reservation for and, for past activities, include attendance information for these activities where it has been provided by the corresponding activity manager 110. The attendance report for an activity user may include all activities on record for said activity user, or may only include a subset of all activities on record for said activity user, for example all activities in the last three months, or all activities for which a reservation has been placed by one or more identified search users. For example the attendance report may include only activities that have been reserved for by the activity user's doctor, dietician or physiotherapist and may not include activities reserved for by the activity user or by another search who is not the activity user's doctor, dietician or physiotherapist. In some examples, the reporting unit is arranged to build attendance statistics in respect of one or more activity users, one or more search users and/or one or more activities. In other examples the reporting unit may not be arrange to build such attendance statistics and, optionally, may be arranged to provide attendance data to an element for the element to cause such attendance statistics to be build.

In some examples, the reporting unit may not generate a report and, if a report is generated or built, it may be built by an external or third party element. For example, in the illustration where a user has been prescribed physical activity by a doctor, the attendance information may be sent to the reporting unit 112 first and the reporting unit may also forward this information (either in the same form or after the appropriate modifications) to an external attendance tracking unit that the doctor can access. For example the doctor's practice may receive the attendance information and use its own reporting system for generating reports and/or building statistics. In other examples, the service provider may include a hybrid system where reports are built in cases where no additional reporting unit will be used and where attendance information may be forwarded to an external reporting unit (without any reports being built by the service provider).

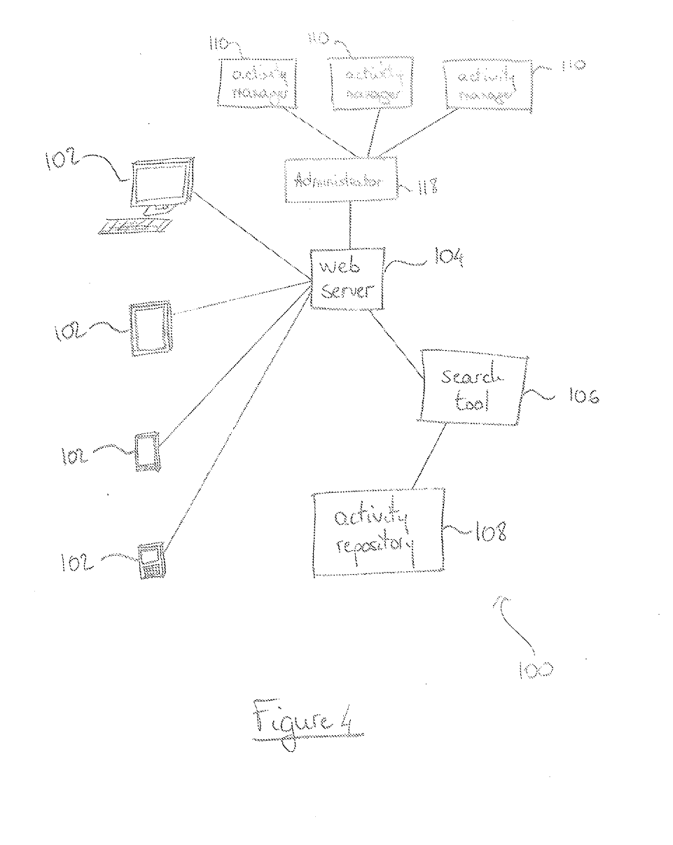

FIG. 4 is an illustration of yet another example system in accordance with the present disclosure. The system 100 illustrated in FIG. 4 comprises devices 102, a web server 104, a search tool 106 and an activity repository, for example as discussed above in respect of FIG. 1. The system 100 also comprises an administrator 118 and a plurality of activity managers 110 (three activity managers in the example of FIG. 1). In this example implementation, the administrator 110 is connected to two activity managers 110 while a further activity manager 110 is connected directly to the web server. Providing an administrator as in the arrangement of FIG. 4 may improve an activity approval process for at least the following reasons. Even the service provider may not wish to modify the activity or exercise an excessive control over the activities provided by the activity providers, it may be desirable to have an approval process in place to reduce the risks of having bogus or objectionable activities included in search results. The administrator 118 may for example have been previously approved and may be authorized to provide activities to the web server 104 (for storage in the activity repository 108). The administrator 118 may for example provide activities directly to the service provider if it is also an activity manager 110 and/or it may provide activities on behalf of a separate activity manager 110 (which, for instance, has not been through an approval process and may thus not be allowed to provide activities directly to the service provider). In an example application of this implementation, the administrator 118 may be a sport club manager who has successfully been through an approval process and the activity managers may be the managers in charge of the 5-9 year group, 10-13 year group, 14-18 year group and 19+ year group, respectively.

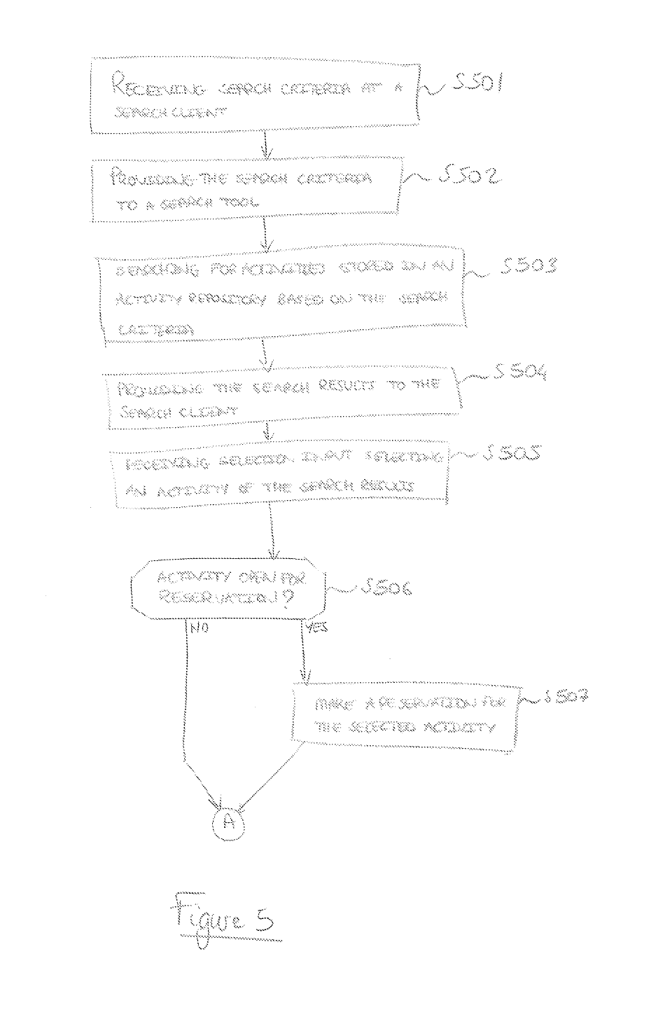

FIG. 5 is a flowchart illustrating an example method in accordance with the present disclosure. At step S501, search criteria are received at a search client. The search criteria comprise a search description, a search location and a search time period for finding activities in an activity repository, the activity repository storing, for each of a plurality of activities, an activity title, an activity location, and an activity time period. The activities stored in the activity repository have been provided by a plurality of activity managers. The search criteria are provided to a search tool at step S502, for example with the search client sending the search criteria to the search tool (e.g. via a web server) in one or more messages. At step S503 activities stored in the activity repository are searched based on the search criteria. As discussed above, this search may in some examples comprise two searches which may be carried out sequentially and/or in parallel. For example the additional search may not be based on the search criteria or may only be based on some but not all of them. Once the activities have been searched, the corresponding search results are provided to the search client at S504. The search results comprise activity data relating to at least one activity identified by the searching. At step S505, selection input is received at the search client wherein the selection input is for selecting an activity of the search results. For example a search user using the search client may have identified an activity of interest among the search results provided at step S504. At step S506 it is determined whether the selected activity is open for reservation. If it is open for reservation, a reservation is made at step S507. After step S507 or if it is determined at step S506 that the activity is not open for reservation, the method moves to “A”. In some implementations, the method will end at this “A” stage while in other implementations the method will continue (for example with reporting attendance of the activity user for the selected activity). FIG. 6 is a flowchart illustrating an example method in accordance with the present disclosure. At step S601, activity managers provide an activity to the service provider. For example two or more activity managers may each provide one or more activities to the service provider. As discussed above, an activity may be provided in any suitable manner, which in some examples may be via a web interface or an application used by the activity manager. The service provider stores the activities in the activity repository at step S602. At step S603, search criteria are input via a search client, wherein the search criteria can be used by a search user for identified possible activities of interest and at step S604 the search tool searches for activities in the activity repository based on the search criteria. Advantageously, the search tool can carry out the search with simple search criteria, such as an entry for each of the “what?” “when?” and “where?” questions, thereby improving the user experience and increasing the chances of the search resulting in a reservation and thus improving the business and, in the case of health or sport activities, the health and well-being of the users.

At step S605, the search tool outputs the search results for the activity search based on the search criteria and at step S606, the search client outputs said search results. For example, if the search client is web based, it may display the search results on a web page in any suitable manner (e.g. all search results being shown on one page or by pages of up to 10 activities) or if the search client is an application running such as computer, smartphone or tablet application, the search results may be output on the application's GUI. In other examples, the search results may be output by printing or by generating a file (e.g. to be downloaded by or sent to a user) or in any other suitable manner.

At step S607, the search client receives an input selecting an activity. For example, a search user may have clicked on a web-based link or button to flag the activity or may have selected the activity using an application-based activity. At step S608, it is determined whether the selected activity is open for reservation. Examples of activities open for reservation include gym classes or sessions, golf tee time, horse-riding lessons or concerts and examples of activities not open for reservation include running (e.g. the activity may provide the user with a running track in his or her area) or public performances. If the selected activity is open for reservation, a reservation is placed for the selected activity at step S609. If the selected activity is not open for reservation or after step S609 has been performed, the method moves to “B”. In some implementations, the method will end at this “B” stage while in other implementations the method will continue (for example with reporting attendance of the activity user for the selected activity).

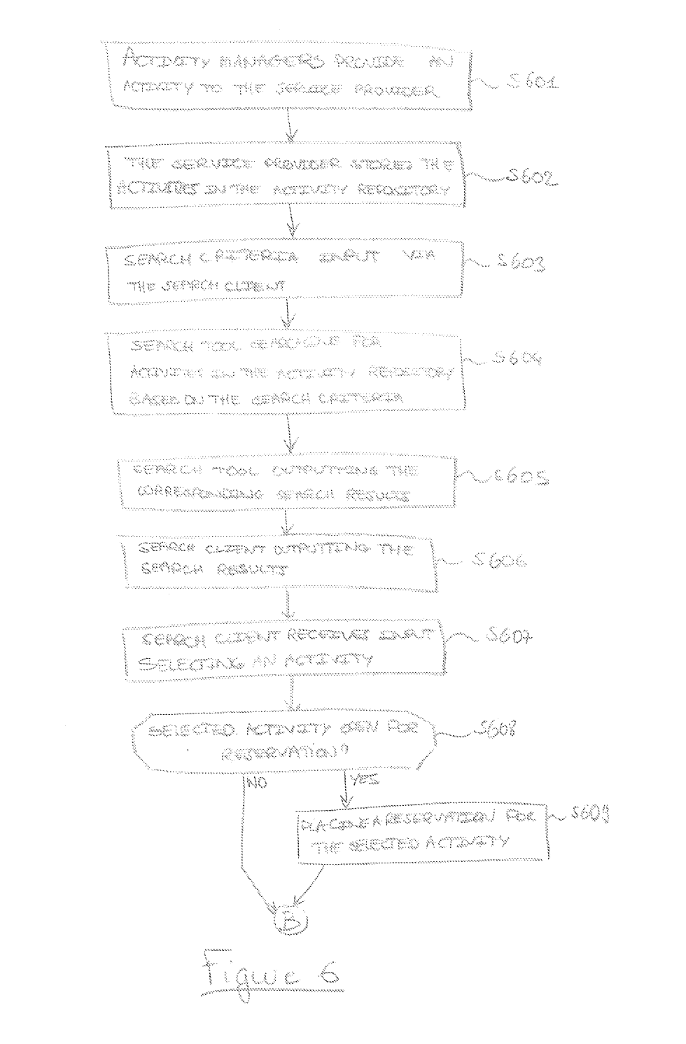

FIG. 7 is an illustration of an example message flow in accordance with the present disclosure. In this example, a search client 103, a search tool 104, an activity repository 108, a reporting unit 112, an activity manager 110 and an attendance supervisor 114, other elements may be involved in this example or in other examples. In FIG. 7, the search tool 106, activity repository 108 and reporting unit 112 have been represented in a dashed-line box to illustrate that they are elements which are directly under the service provider's supervision. The search client 103 may be provided by the service provider (e.g. as a web-based interface or as a program for a computer, tablet or smartphone) and will be used and managed (e.g. installed, accessed and/or uninstalled) by a device's user. At step S701, activity manager 110 provides an activity to the activity repository 108 of the service provider and the activity is stored in the activity repository at step S702. The steps S701 and S702 may be repeated as many times as necessary and may be carried out by two or more different activity managers 110.

At step S711, a search client 103 is input search criteria and the search criteria are sent at step S712 to the search tool 106 for searching for activities corresponding to the criteria. The search criteria may be forwarded unchanged to the search tool 106 or the search client 103 may modify them for sending them to the search tool 106. In one example, the search criteria may be sent unchanged as part of a message (e.g. sent in an xml file) or may be changed by adapting the content and/or format. For example, when implementing the search client 103, it may be decided that if the search client 103 is web-based (e.g. provided by a web page), the search criteria may be sent unchanged as part of an html or xml file and if the search client 103 is provided as a standalone application, the search criteria may have their content and/or format adapted before being sent. For example if the search location input to the search client 103 as part of the search criteria is “Chicago”, the search criteria may be sent including for the search location “ZIP code: unknown; City: Chicago; State: IL”. In another example, if the search location is “my location”, the search client 103 may be implemented to always include the location information it can obtain, such as “unknown”, GPS coordinate, an area (e.g. a GPS coordinate and a range from the coordinate such as “10 feet”), an IP address (from which a location may be retrieved) and/or cellular location information. Of course, the present disclosure is not limited to these implementation choices and any other suitable implementations may be used.

At step S713, the search tool retrieves search results from the activity repository using a query and it receives the response at step S714. In some examples, the searching algorithm or algorithms used for identifying relevant activities in the activity repository 108 may include exact, approximate and/or fuzzy algorithms. By exact algorithms, it is intended to include at least algorithms where the search result will match exactly at least the relevant criterion. By approximate algorithms, it is intended to include at least algorithms where the results to do necessarily exactly match the relevant criterion but requires at least some correspondence with the criterion, such as a term of the criterion or activity description being contained in the activity description or criterion, respectively or an overlap or another form of similarity in the criterion and activity description. By fuzzy algorithms, it is intended to include algorithms using fuzzy logic to determine a degree of correspondence between an activity description and a search criterion. Any combination of such algorithms may be used for each of or all of the search criteria. After receiving the response from the activity repository at step S714, the search tool 106 outputs search results and sends the search results to the search client 103 at step S715.

In the event that the search user identifies an activity of interest in the search results, it can cause the search client 103 to receive an input selecting said activity (S721). In the event that the selected activity is open for reservation and upon reception of such an input, the search client 103 sends an activity reservation request to the activity manager 110 at step S722. Even though in FIG. 7, the activity reservation request has been schematically represented as being sent directly to the activity manager, it may be sent to the activity manager either directly or indirectly (e.g. via a web server such as web server 104 illustrated in FIG. 1). In response to the activity reservation request, the activity manager 110 responds with a reservation response at S723. In the event that the reservation unsuccessful, this may be indicated in the reservation response with, optionally, an error code or another type of indication of the reason (if known) for the unsuccessful attempt at reserving the activity. In the event that the reservation is successful, the reservation response may include information such as a confirmation, a reservation number, terms and conditions for the activity (e.g. a URL or document for setting out the terms and conditions), and/or a contact number. Additionally, even though two messages have been represented, more messages may be sent for carrying out the reservation process. For example, first messages may be sent for the user to try to reserve the activity for a limited time (e.g. using a timer) and second messages may be sent to arrange for payment for the temporarily-reserved activity. In this example, the final reservation response may for example be sent once the payment has been confirmed and the activity has been reserved for the user, once the timer has expired before a successful payment has been received or once the payment for the activity has been refused. In the event that the reservation is successful, the reporting unit can store selection information which may in this case indicate that the activity has not only been selected but also successfully reserved. In the example of FIG. 7, this is cause by the reservation confirmation message sent by the activity manager 110 at step S724. Even though step S724 has been represented after step S723 in the illustration of FIG. 7, in other examples, these two steps may be carried out simultaneously, or step S724 may be carried out prior to step S723.

In the example of FIG. 7, the activity manager 110 can send attendance information to the reporting unit (step S731) to inform the reporting of the activity user's attendance to the selected activity (which is also a reserved activity in the example of FIG. 7). In some examples, the activity manager 110 may only send attendance information if the user attended the activity while in other examples, the activity manager may send attendance information after the activity finished and/or periodically. For example, if the activity is a yoga lesson, it may be more appropriate to send attendance information after the yoga lesson is finished. In another example, if the activity is a monthly subscription to a gym, it may be appropriate for the activity manager (e.g. the sport center or gym manager) to send attendance information periodically, such as weekly or monthly, to indicate whether the activity user has been going to the gym. At step S732, upon receipt of the attendance information, the reporting unit 112 can build an attendance report. The attendance report may for example be for monitoring the activity attendance for the activity user. In other examples (not illustrated in FIG. 7), upon receipt by the reporting unit, the attendance information may be stored and be made available for a later generation or build of the attendance report, for example upon request from an attendance supervisor 114.

At step S741, attendance supervisor 114 sends an attendance report request to the reporting unit 112. The request may for example indicate for which one or more activity users the report should be sent. In the case where the attendance supervisor 114 requests an attendance report for two or more users, it may sends request one or more reports as a response, wherein each report may be for an individual activity user or for a group of (i.e. two or more) activity users. At step S742, the reporting unit 112 returns an attendance report (or more, if appropriate) to the attendance supervisor 114. As previously mentioned, in some implementations, the reporting unit 112 may generate the attendance report upon receipt of an attendance report request rather than in advance to receiving such a request.

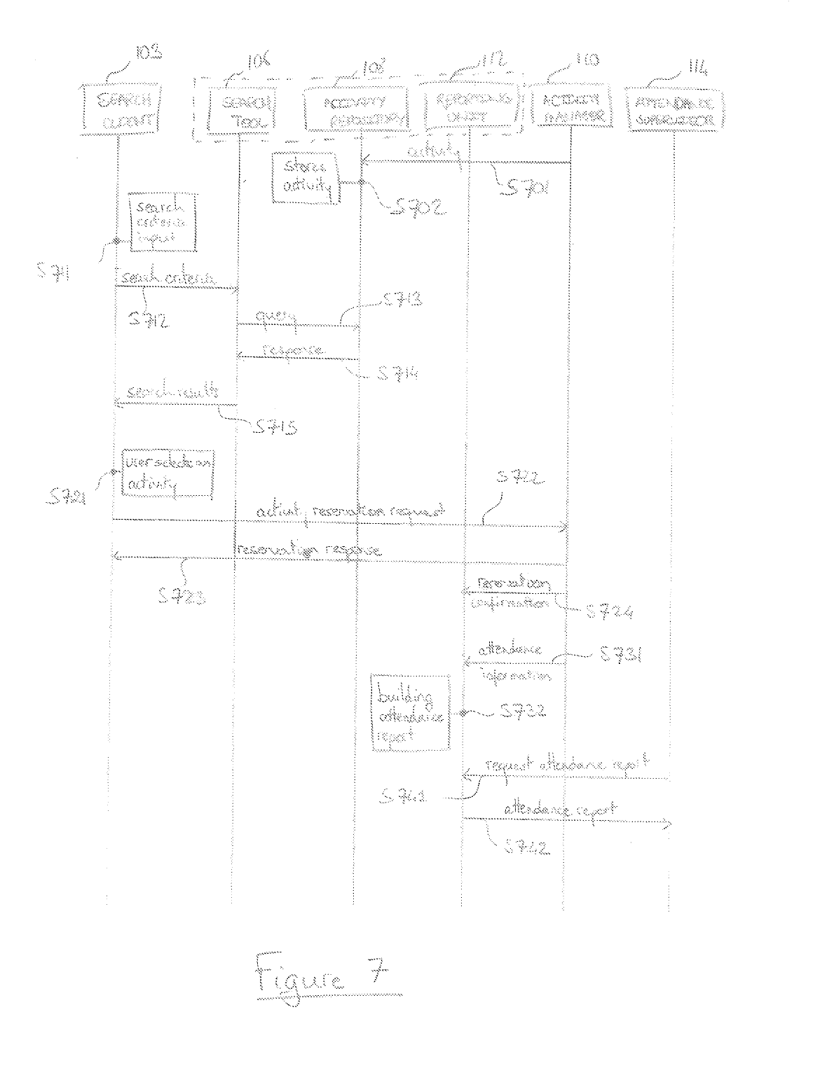

FIG. 8 is an illustration of another example message flow in accordance with the present disclosure. In the illustration of FIG. 8, only communications between elements have been represented in the interest of conciseness only and, for example, events such as S702 or S711 illustrated in FIG. 7 have not been represented in FIG. 8. One of the differences between the example of FIG. 7 and the example of FIG. 8 is the provision of a server element 116 as an additional element of the service provider. In some implementations where a web server is provided, the server element 116 may for example be physically and/or logically provided in the same element as the web server. As in FIG. 7, the dashed-line box illustrates which elements are under the direct supervision of the service manager in this example implementation.

At step S801, the activity manager 110 provides at least one activity to the server element 116 which, in turn, provides the at least one activity to the activity repository at step S802, for the activity repository 108 to store it.

If search criteria are input via the search client 103, the search client can then send the search criteria to the server element 116 (step S811). Upon receipt, the server element 116 can then send the search criteria to the search tool 104 (step S812). In some examples, the messages at S811 and S812 may be substantially the same are very similar. For example the server element may forward the message received from the search client 103 directly to the search tool 104 (e.g. it may forward the IP payload received from the search client 103 to the search tool 104). In other examples, the server element 116 may generate a different message to send the search criteria to the search tool 104, for example by modifying the content and/or encoding (e.g. protocol) of the message. As the search tool 104 receives the search criteria, it access the activity repository 108 with a view to identifying activities stored in the activity repository 108 and matching the search criteria to a suitable degree. In the example of FIG. 8, this is achieved with a query sent at step S813 from the search tool 104 to the activity repository, which responds with a response sent at step S814. In other examples, the search tool 104 may access the activity repository 108 differently, such as by sending more queries to the activity repository 108. After the search tool 104 has identified activities, it sends search results to the server element 116 at step S815 and, upon receipt of the search results, the server element 116, sends the search results to the search client 103 at step S816. The search client 103 may then output the search results to the search user, for example for the search user to determine whether to select one or more activities.

If the search user selects an activity and the activity is open for reservation, the search client 103 receives a corresponding selection input indicating the selected activity and, at step S821, an activity selected message is sent to the server element 116 to indicate that the activity has been selected. In the event that the activity is not open for reservation, the search client may also send an activity selected message to the server element 116 (for example for monitoring which activities attract interest from users) and/or may store the selected activity in a local memory—if provided (for example for the user to later find again without having to carry out a new search). After receiving the activity selected message, the server element can send a corresponding reservation request to the activity manager 110 for the selected activity at step S822. In response, the activity manager 110 sends a reservation confirmation to the server element 116 (S823), which can send a corresponding reservation response to the search client 103 (S824) and an activity reserved message to the reporting unit 112 (S825). In cases where the reservation is unsuccessful, the messages sent at steps S823 and S824 may instead aim at notifying the search client 103 that the reservation has failed. Additionally, in the example of FIG. 8 the server element 116 first sends a reservation response to the search client 103 and then sends an activity reserved message to the reporting unit 112. However, these messages may be sent in any appropriate order. For example, the activity reserved message may be sent before or substantially at the same time as the reservation response message.

The activity manager for the selected activity can then later send attendance information to the server element 116 (S831) which can send said attendance information to the reporting unit 112 (S832). Upon receipt of the attendance information, the reporting unit 112 can store the attendance information. It may also build an attendance report for the activity user. In some cases, this would involve generating a new report, updating an existing report, replacing an existing report or storing a new version of the report.

If an attendance supervisor 114 sends an attendance report request to the server element (S841), the server element 116 can send the attendance report request to the reporting unit at step S842. Upon receipt of this request, the reporting unit 112 can output an attendance report (e.g. by retrieving an attendance report which has already been generated or by generating or building an attendance report) and send it to the server element 116 (S843). At step S844, the server element 116 sends the attendance report to the attendance supervisor in response to the request sent at step S841.

In the example of FIG. 8, the server element 116 is mainly used as an element for centralizing all communications to or from the service provider to other parties, such as search clients 103, activity managers 110 or attendance supervisors 114. This may provide a more flexible architecture for the service provider as, in the event that the service provider decides to change the logical and/or physical location of or the architecture for the search tool 104, activity repository 108 and/or reporting unit 112, the service provider can simply adjust the server element 116 accordingly, without making any changes to, or notifying, the search clients 103, activity managers 110 or attendance supervisors 114. In other examples, more than one server elements 116 may be provided. For example, a first server element may be provided for communications with search clients 103, a second server element may be provided for communications with activity managers 110 and/or a third server element may be provided for communications with attendance supervisors 114. Also, some of the search clients 103, activity managers 110 and attendance supervisors 114 may use one or more server elements 116 when communicating with the service provider, while the others of the search clients 103, activity managers 110 and attendance supervisors 114 may communicate with the service provider by communicating directly with the relevant element within the service provider (e.g. the search tool 104, activity repository 108 and/or reporting unit 112).

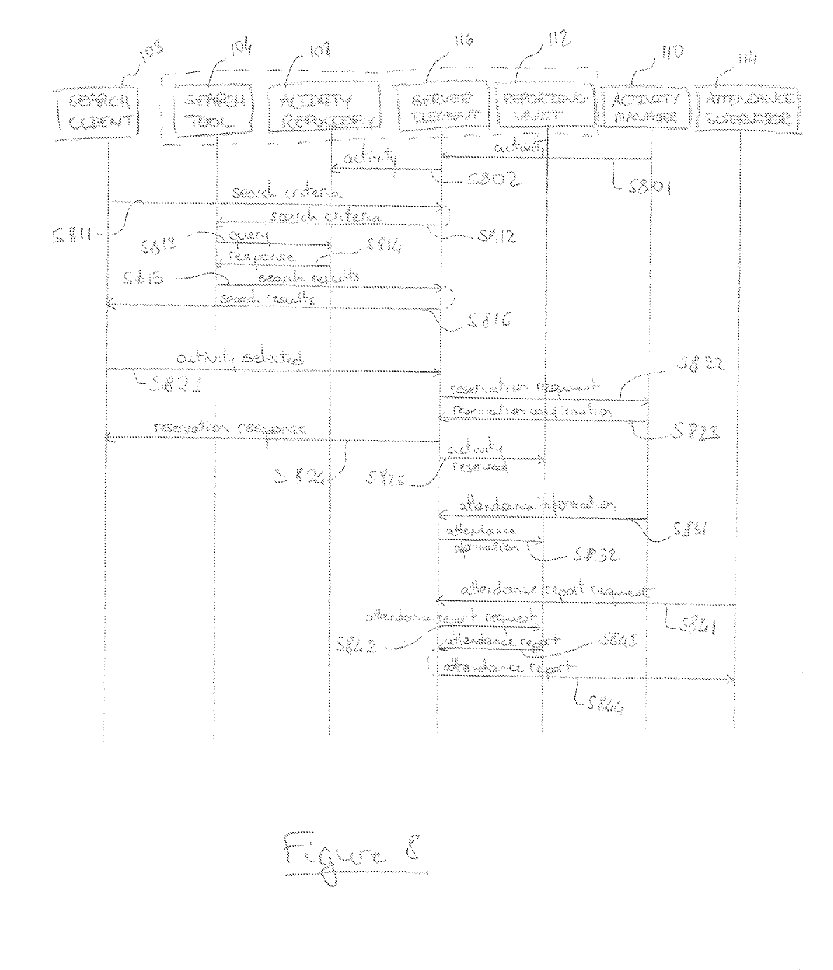

FIG. 9 is an illustration of an activity repository 108 in accordance with the present disclosure. In this example, the activity repository 108 comprises a database (“DB”) 1081 storing data, such as records or tables 1082a-1082c. The DB 1081 is connected to a DB manager 1084 which is arranged to access the DB 1081, for example to store, access, update, delete and/or back up data in the DB 1081. The DB manager 1084 is also connected to a transceiver (“TX/RX”) 1083 which is arranged to process communications to/from the activity repository, such as a network interface or card. For example if the activity repository 108 receives a request for all activities stored in the DB matching certain search criteria, the message will be received by the TX/RX 1083 which may remove parts of the message which are no longer required and forward the request carried by the message to the DB manager 1084. In turn the DB manager 1084 can query the DB 1081 according to the content of the request and have search results returned in response to the query. The DB manager 1084 can then forward the search results to the TX/RX 1083 which can then generate a message for sending the search results, for example to a search tool 104. The DB 1081 may comprise one or more tables and tables and/or data in tables may be linked to one another. For example, the table 1082a may be a table of activities provided by activity managers 110 and table 1082b may be a table of activity managers, wherein the table 1082a, if indicating the activity manager for activities, may identify an activity manager using an index or hash key. The activity manager table 1082b may then comprise information for each activity managers such as a name, an identifier, a postal and/or email address, a phone number, a sign-up date, an account manager's name or identification, and/or a number of activities provided.

The example activity repository 108 of FIG. 9 is provided for illustrative purposes only and the activity repository 108 may be arranged or provided in any other suitable manner. For example, in some implementations, it may be provided as part of the same element as the search tool 104 or it may be provided as a standalone element with more or fewer elements.

FIG. 10 is an illustration of an activity table 1082a in accordance with the present disclosure. In this example, the table comprises 7 entries for storing activities. The “ID” (for “identifier”) column may be used as an index to identify the activity and is thus preferable a unique identifier. The “Activity Name” column may be used to briefly describe the activity and may for example be used if listing the search results to a search user so that the search user can quickly identify what the activity is for. The “Description” column may be a text entry (generally longer than the one in the activity name column) which provides a more extended description of the activity. This may for example be provided (fully or partially) to a search user when listing search results and/or when a search user wishes to know more about the activity (e.g. by clicking on a “more” button or link for the activity on a web page or web-based interface). The “Activity Manager” column identifies the activity manager which provided the activity to the service provider. In this example, the activity manager is identified with its name but in other examples, the activity manager may be, alternatively or additionally, identified with an identification number. For example the identification may refer to an entry in an activity manager table stored in the DB 1081 of the activity repository 108. The “Location” column may be used to indicate the location for the activity. In some example, there may be one or more location columns, for example to store text describing the location (as illustrated in FIG. 10) in one column and GPS coordinates (not shown) in another column. The “Time” column may be used to indicate the time at which the activity scheduled. In other examples, timing information may be provided in two columns, such as a first column for indicating a first timing (e.g. “Tuesday, 10 am-10.45 am) and a second column indicating repetition information (e.g. “weekly, 10 occurrences”). Also, depending on implementation choices, it may be decided that an activity received as a single activity from an activity manager may be stored as two or more activities. For example, the activity with ID “3” in the example of FIG. 10 may be stored as two activities wherein the first stored activity has a timing of Sam-6 pm from April until September and a second stored activity has a timing of 9 am-5 pm from October until March. In the event that an activity is stored as more than one activity entries in the activity table 1082a, the “ID” column may be used to uniquely identify the entry in the table and an additional “Activity ID” column may be provided to uniquely identify the activity in the table. For example, if an activity is stored as two entries in the table 1082a, each of the two entries may have a unique “ID” and both entries would share the same “Activity ID”. The “Reservation” column may be used to indicate whether an activity is open for reservation and, optionally, any limitations for reservations. In the illustration of FIG. 10, the “Reservation” column is used to indicate both whether the activity is open for reservation and/or any limitations but in other examples the table 1082a may include two columns: one to indicate whether the activity is open for reservation and one to indicate, if the activity is open for reservation, any limitations on the reservations. The details of an activity stored in the activity table 1082a can for example be used to identify whether an activity is a match for a set of search criteria or to display information on the activity when an activity has been identified as being part of search results.

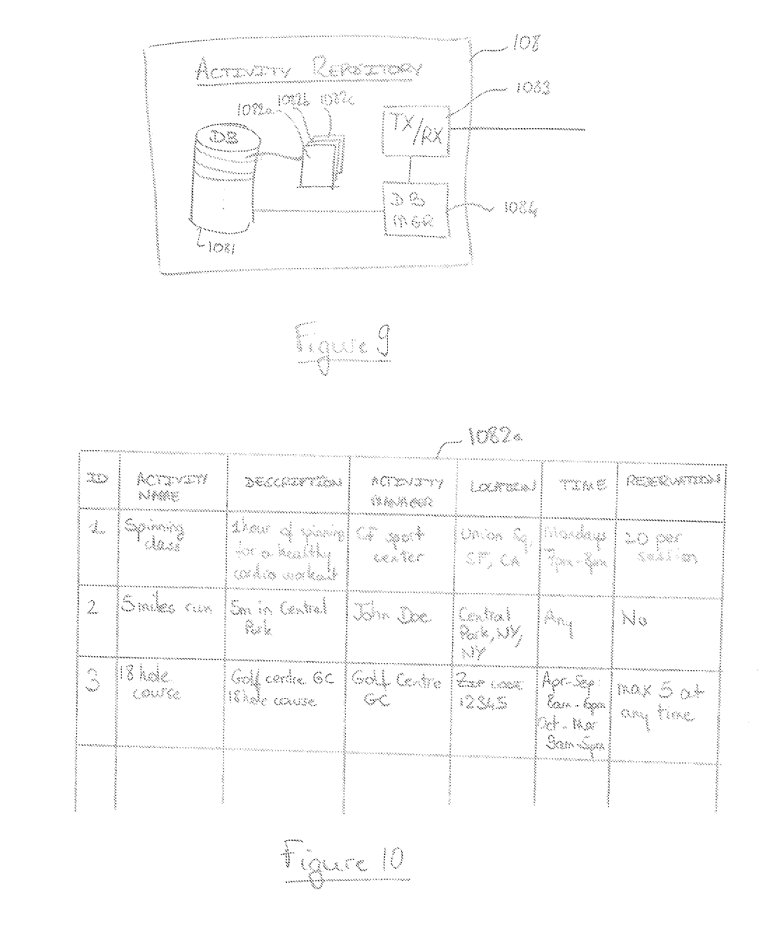

FIG. 11 is an illustration of a search tool 106 in accordance with the present disclosure. The example search tool 106 of FIG. 11 comprises a search logic 1061, a memory 1062 and an TX/RX 1063. As a search request message arrives at the search tool 106, it arrives via the TX/RX 1063 which can carry out conventional network or communications actions (e.g. to transmit and receive messages) and forwards the request to the search logic 1061. The search logic 1061 can then store, at least temporarily, the search criteria in memory 1062 for use during the search. The search logic may be arranged to implement one or more search algorithms (two search algorithms in the illustration of FIG. 11) and may be arranged to select which one or ones of said algorithms to use when carrying out a search. This may for example be based on user preferences and/or on the search criterion. For example, the search logic may be arranged to use a first search algorithm when identifying activity descriptions matching the search description of the search criteria and a second search algorithm when identifying activity locations matching the search location of the search criteria. Based on the search algorithm(s) and search criteria, the search tool 106 can access the activity repository 108 with a view to identifying matching activities. In one example, this is achieved by the search logic 1061 sending one or more queries for the activity repository 108 to the TX/RX 1063 which is arranged to send the queries in one or more messages to the activity repository 108. If the TX/RX 1063 then receives one or more messages carrying responses to the queries, it may process the messages and forward the responses to the search logic 1061 which, in turn, may generate the search results. As previously mentioned, search results ordering information may be provided along with the search results. For example, the search logic may include, for each activity in the search results, a correspondence degree indicating the degree to which the activity matches the search criteria or one or more of the search criteria. Once the search results have been generated, the search logic 1061 can send the search results to the TX/RX 1063 which is arranged to send the search results to the relevant party (e.g. the search client 103) in one or more messages. Once the search results have been sent by the search logic 1061 and, optionally, once the search logic 1061 receives the confirmation that the transmission of the search results has been successful, the search logic may free the memory areas that were being used in memory 1062 for carrying out the search (e.g. for storing search criteria, responses to queries to the activity repository and/or search result information). For example, it may erase the data stored in these memory areas, un-reference them and/or mark them to indicate that they can now be overwritten.

In the examples of FIGS. 7 and 9, the search tool 106 and the activity repository 108 have been represented as two separate elements, on other examples they may be two logical entities in the same physical element. For example, they may share the same TX/RX and the search logic 1061 may be directly connected to the DB manager 1084 for accessing the DB 1081 when carrying out a search.

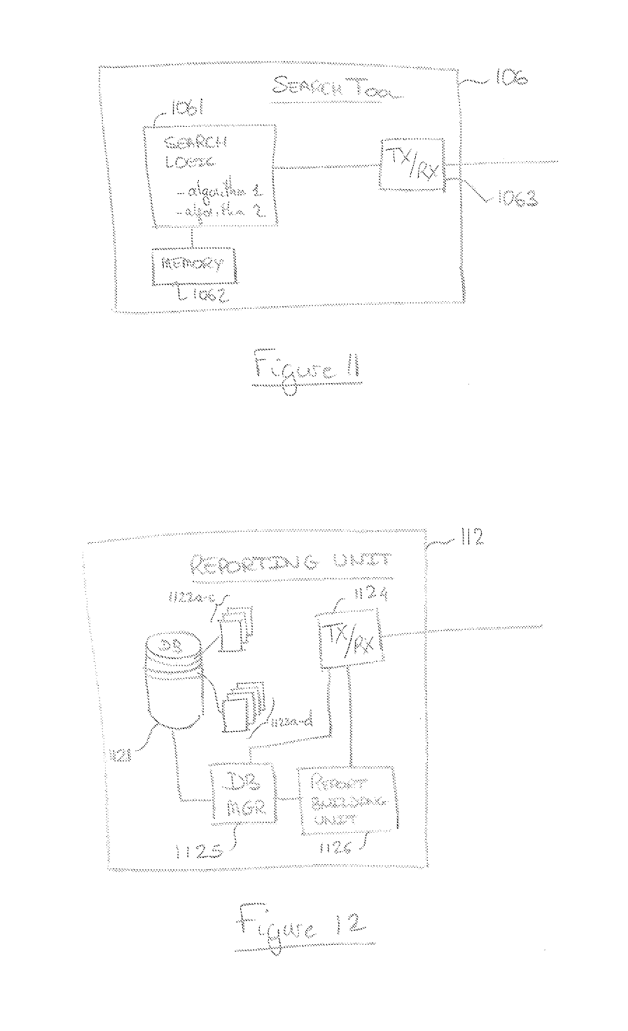

FIG. 12 is an illustration of a reporting unit 112 in accordance with the present disclosure. In this example, the reporting unit 112 comprises a database (“DB”) 1121 storing tables or files such as 1122a-1122c and 1123a-1123d, a DB manager 1125, a report building unit 1126 and an TX/RX 1124. The TX/RX of the example of FIG. 12 can carry out functions similar to those of the TX/RX of the search tool 106 and activity repository 108 illustrated in FIGS. 9 and 7, respectively. The DB 1121 may be arranged to store one or more tables and/or one or more files. In the example of FIG. 12, the group of tables 1122a-1122c may be for tables storing attendance information as received by the reporting unit 112 from the activity managers 110 while the group of files 1123a-1123d may be for storing attendance report files. The DB manager 1125 is arranged to access the DB 1121, for example to store, access, update, delete and/or back up data in the DB 1121. It is also connected to the TX/RX 1124, for example to store attendance information received by the TX/RX 1124 which may forward the attendance information to the DB manager 1125. The DB manager 1125 is also connected to the report building unit 1126. The report building unit 1126 may for example communicate with the DB manager 1125 for querying the DB 1121, for example when generating an attendance report. The report building unit 1126 is operable to generate or build attendance reports for an activity user when attendance information is received via the TX/RX 1124 and/or when receiving an attendance report request via the TX/RX 1124. The report building unit 1126 may also be operable to store attendance reports in attendance report files 1123a-1123d in DB 1121, for example by sending the files to be stored to the DB manager 1125 which can in turn cause the files to be stored in DB 1121. In some examples, the attendance report unit 1126 may be operable to generate various types of attendance reports. For example, it may operable to generate an attendance report for one activity user, for a group of activity users (e.g. based on the activity user's location to try to generate statistics based on users' location), for one search user, for a group of search user, for one or more activity managers and/or for any combination of the above.

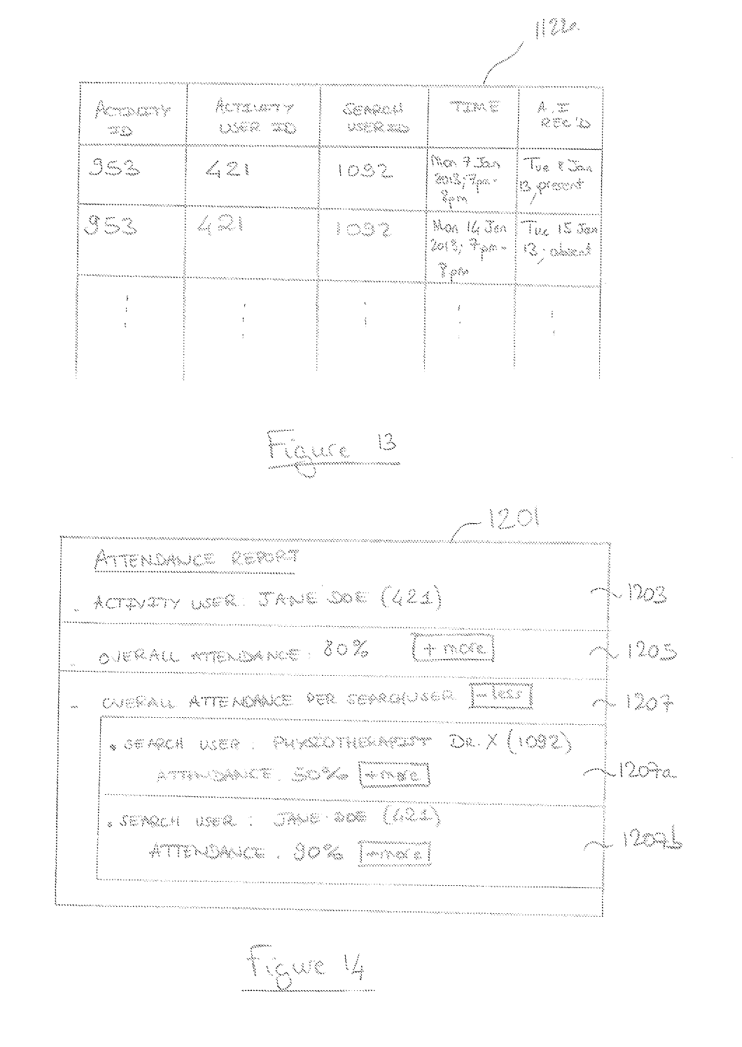

FIG. 13 is an illustration of an attendance information table 1122a in accordance with the present disclosure. The table 1122a comprises 5 columns, “Activity ID”, “Activity User ID”, “Search User ID”, “Time” and “A.I. Rec′d” (for “Attendance Information Received”). The “Activity ID” column may be used to identify the activity to which the attendance information relates to, for example by referring to a unique activity identifier. The “Activity User ID” column may be used to identify the activity user for which the activity had been reserved, for example by referring to a unique activity user identifier. The “Search User ID” column may be used to identify the search user who has placed the reservation for the activity user, for example by referring to a unique search user identifier. The “Time” column may be used to indicate the activity time to which the attendance information relates. For example, in the example of FIG. 13, the two entries shown relate to the same activity, activity user and search user but relate to two different times for the same activity: the first entry relates to an occurrence of the activity at a first time and the second entry relates to a different occurrence of the activity at a second time, a week after the time. This may for example be how some attendance information may be received for activities which occur weekly and for which the activity user is registered (i.e. the activity has been booked for this user) weekly. The “A.I. Rec′d” column may be used to indicate when attendance information was received and the attendance status. In other examples, this column may only indicate the status and, optionally, another column may be provided to indicate the time of receipt of the attendance information.

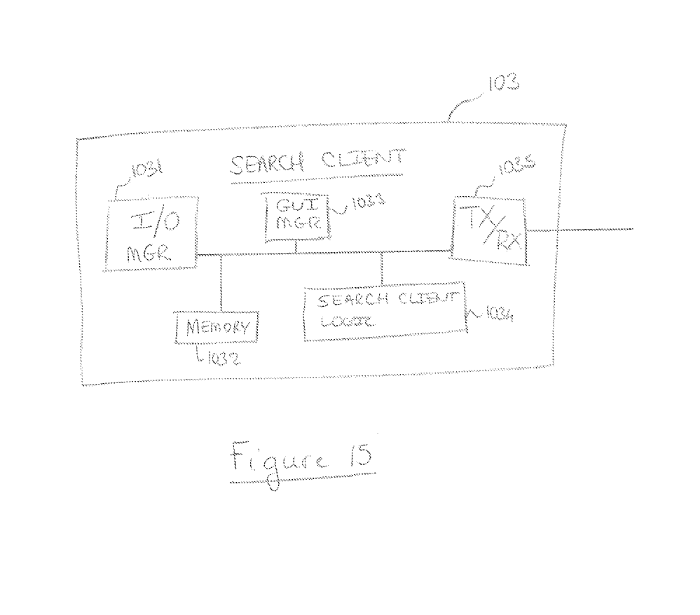

FIG. 14 is an illustration of an attendance report 1201 in accordance with the present disclosure. This example attendance report 1201 may be particularly well suited to web-based display but it may also be used with other types of interfaces and, other types of attendance reports may be used with web-based interfaces or other types of interfaces. This attendance report 1201 comprises three main sections 1203, 1205 and 1207 and two sub-sections 1207a and 1207b. The first main section 1203 identifies the activity user for which the report has been generated and, in this case, it also indicates the activity user's unique identifier. The second section 1205 indicates the overall attendance for this activity user. In this example, this is indicated with a percentage, but in other examples, it may be illustrated alternatively or additionally with one or more graphics. Also, in this example, this second section 1205 can be expanded and has been represented in a collapsed mode, with a “more” button or link for a reader to expand the section if they wish. The third main section 1207 is for indicating activity attendance for this activity user, where the activities have been grouped by search users. In this example, this section is also expandable and it has been illustrated in the expanded mode and includes two sub-sections 1207a and 1207b. The first sub-section 1207a relates to activities reserved for “Jane Doe” for which the search user was search user “1092”, i.e. “physiotherapist Dr. X” while the second sub-section relates to activities reserved for “Jane Doe” by herself. In this example, the sub-sections are also expandable, for example to show the detail of the activities reserved and the corresponding attendance information but in other examples, the sub-sections may not be expandable.

Other examples of attendance reports are also considered under the present disclosure, for example where the attendance information is organized in a different manner or where different attendance statistics are calculated and provided. Also, even though the attendance report illustrated in FIG. 14 has been illustrated in display mode, i.e. to illustrate how it can be displayed to a reader, the expression “attendance report” according to the present disclosure is also intended to included files, for example xml files, which can later be displayed as illustrated in FIG. 14 (or differently).

FIG. 15 is an illustration of a search client 103 in accordance with the present disclosure. The example search client of FIG. 15 comprises an Input/Output (“I/O”) manager 1031, a memory 1032, a GUI manager 1033, a search logic client and transceiver (“TX/RX”) 1035. The I/O manager 1031 may be arranged to receive inputs from a user of the search client 103, for example via a keyboard, touchscreen, remote control, microphone or mouse, and to provide outputs to a user of the search client 103, for example via a screen, speakerphone or haptic feedback element. The memory 1032 may be used to store data, for example for a short or long period of time or in a volatile or non-volatile manner. The GUI manager 1033 may be arranged to process inputs received via the I/O manager 1031 and to generate a display to be output to the user via the I/O manager. For example, the GUI manager 1033 may be operable to generate an interface, populate some fields or areas of the interface using instructions from the search client logic and/or data read from the memory and may output display data for the I/O manager 1031 to output to the user on a screen. The search client logic 1034 may be arranged to process inputs received via the I/O manager 1031 and messages received from the TX/RX 1035. The search client logic 1034 may also be operable to cause the I/O manager 1031 to generate an output and/or the TX/RX 1035 to send messages based on the outcome of said processing. For example, upon identification that search criteria have been received via the I/O manager 1031, the search client logic 1034 may cause the TX/RX 1035 to send one or more messages carrying the search criteria to the search tool 106. In another example, upon receipt (via the TX/RX 1035) of one or more messages carrying search results, the search client logic 1034 may be arranged to provide the GUI manager 1033 with instructions to display the search results using the I/O manager 1031. For example the search logic client 1034 may be operable to order the results based on ordering information provided with the search results and based on user preferences retrieved from the memory 1032 and to instruct the GUI manager 1033 to generate a display based on this order. If an input is received, via the I/O manager 1031, that the search results should be ordered differently (for example based on distance to the user's location rather than based on users' reviews), the search client logic 1034 may be arranged to re-order the search results and to instruct the GUI manager 1033 to update the display accordingly. The TX/RX 1035 of the search client illustrated in FIG. 15 may carry out functions similar to those of the TX/RX of the search tool 106, activity repository 108 and reporting unit 109 illustrated in FIGS. 9, 7 and 10, respectively.

Other embodiments and alternatives than those discussed are also considered under the present disclosure. For example the logic for placing reservation may be hosted and/or managed by the service provider rather than with the activity manager as previously discussed. Also, some of the elements discussed above (e.g. search tool 106, activity repository 108 and/or reporting unit 112) may be provided as separate physical elements or may be provided in a single physical element. For example, they may all be provided in a single server and may for example share the same TX/RX or database.

In some implementations, the platform may be provided such that users are grouped on “private groups” such that they can for example be managed separately to a public user, if any. For example, a company may wish to subscribe to the service for its employees. Invitations or group emails can be sent to invite them to activities which, in some cases, may only be open to them and the type and number of activities that these employees can find or reserve may for example be different to those that a public user can find or reserve. In some examples, the users in such a private group may for example have discounted prices for some paying activities. This can be advantageous for example for improving health and wellbeing of all staff within a company or an entity, in particular by making the access to the reservation system easier and more flexible than before. Also this arrangement can provide useful information for identifying the benefits of physical activities (for example to try to analyze any link between a number of activities and absenteeism and/or efficiency at work) which was not available before and can also be helpful when trying to quantify the effect of fitness on staff.

Additionally, any of the elements discussed herein may be provided in a virtual and cloud environment such that, even though they might be treated as being in a separate server, this separate server may be a virtual server hosted by one or more physical servers.

Moreover, data stored in the databases may be stored in different structures than those illustrated in the figures, for example data may be stored in lists, in xml files or in any other suitable data structure which the skilled person believes is appropriate. When the data is provided tables, said tables may have more or fewer columns, and different columns that those illustrated in the figures and discussed above.

The term logic as used herein is intended to refer to an element which is operable to cause operations to be carried out using processing resources and may be implemented in any hardware form, software form or combination thereof. Whenever the present disclosure uses the term “user”, this term should be understood to mean any type of user, including a human being or a machine-type user.

Thus, viewed from one approach, there has been described a method for finding and reserving activities, the method comprises receiving, at a search client, search criteria wherein the search criteria comprise a search description, a search location and a search time period; providing the search criteria to a search tool; searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results; and making, in the event that the selected activity is open for reservation, a reservation for the selected activity.

A set of numbered clauses are now presented by way of further indication of feature combinations falling within the present disclosure.

Clause 1. A method for finding and reserving activities, the method comprising: receiving, at a search client, search criteria wherein the search criteria comprise a search description, a search location and a search time period; providing the search criteria to a search tool; searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results; and making, in the event that the selected activity is open for reservation, a reservation for the selected activity.

Clause 2. A method according to clause 1 wherein the making a reservation comprises: providing, from the search client to an activity manager, an activity reservation request for the activity selected by the selection input.

Clause 3. A method according to clause 2 wherein the making a reservation comprises: receiving, at the search client, an activity reservation message confirming that a reservation for the selected activity has been made.

Clause 4. A method according to clause 1, 2 or 3, the method further comprising: providing, from a first activity manager, at least a first activity to the activity repository; providing, from a second activity manager, at least a second activity to the activity repository; storing, at the activity repository, the at least first and second activities.

Clause 5. A method according to any preceding clause, wherein the plurality of activity managers comprises a sport center, a sport club or a healthcare provider and/or wherein the plurality of activities comprises sport and/or health related activities.

Clause 6. A method according to any preceding clause, wherein a time period comprises at least one of a date, a time range, a starting time, a duration, an ending time and a repetition frequency.

Clause 7. A method according to clause6 wherein a repetition frequency can be at least one of a daily, weekly, bimonthly, monthly, or yearly frequency.

Clause 8. A method according to any preceding clause, wherein searching for activities matching the input search criteria comprises searching based on an exact, approximate and/or fuzzy search algorithm.

Clause 9. A method according to any preceding clause, wherein the searching further or alternatively comprises searching for activities matching one or more criteria derived from a stored profile.

Clause 10. A method according to any preceding clause, wherein making a reservation for the selected activity comprises storing selection information, by a reporting unit, wherein the selection information identifies the selected activity and a corresponding user.

Clause 11. A method according to clause 10, the method further comprising: communicating activity attendance information from an activity manager and to the reporting unit, wherein the attendance information is for the selected activity and the corresponding user; and building, using the reporting unit, an attendance report for the corresponding user, the attendance report comprising activity attendance information for selected activities for said corresponding user.

Clause 12. A method according to clause 11, wherein the building of said attendance report comprises building the attendance report upon receipt of an attendance report request from an attendance supervisor and/or upon receipt of the activity attendance information.

Clause 13. A method for finding and reserving activities, the method comprising: receiving, at a search client, search criteria wherein the search criteria comprise a search description, a search location and a search time period; providing the search criteria to a search tool; searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers; providing, using the search tool, the search results to the search client, the search results comprising activity data relating to at least one activity identified by the searching; receiving, at the search client, selection input selecting an activity of the search results; and in the event that the selected activity is open for reservation: making a reservation for the selected activity, making a reservation for the selected activity comprising storing selection information, by a reporting unit, wherein the selection information identifies the selected activity and a corresponding user; communicating activity attendance information from an activity manager and to the reporting unit, wherein the attendance information is for the selected activity and the corresponding user; and building, using the reporting unit, an attendance report for the corresponding user, the attendance report comprising activity attendance information for selected activities for said corresponding user.

Clause 14. A system for finding and reserving activities, the system comprising: an activity repository, wherein the activity repository comprises: activity storage which stores activities provided by a plurality of activity managers, wherein an activity comprises an activity title, an activity location, and an activity time period, and activity storage logic arranged to manage operations on the activity storage; a search tool, wherein the search tool comprises a search logic arranged to access the activity repository and to search for activities stored in the activity repository based on search criteria and wherein said search criteria comprise a search description, a search location and a search time period; and a search client comprising a search client logic, and an input/output manager arranged to receive inputs from a user of the search client and to provide outputs to a user of the search client, wherein the search client logic is arranged, upon identification that search criteria have been received via the input/output manager, to: retrieve search results obtained, using the search tool, for said search criteria; output said search results using the input/output manager; receive selection input selecting an activity of the search results via the input/output manager; and make, in the event that the selected activity is open for reservation, a reservation for the selected activity.

Clause 15. A search client for finding and reserving activities, the search client comprising: a search client logic, and an input/output manager arranged to receive inputs from a user of the search client and to provide outputs to a user of the search client, wherein the search client logic is arranged, upon identification that search criteria for searching for an activity have been received via the input/output manager, to: provide the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period; retrieve search results obtained, using the search tool, for said search criteria; output said search results using the input/output manager; receive, via the input/output manager, selection input selecting an activity of the search results; and make, in the event that the selected activity is open for reservation, a reservation for the selected activity.

Clause 16. A search client according to clause 15, wherein the search client logic being arranged to make a reservation comprises the search client logic being arranged to provide, to an activity manager, an activity reservation request for the activity selected by the selection input.

Clause 17. A search client according to clause 16 wherein the search client logic being arranged to make a reservation comprises the search client logic being arranged to receive an activity reservation message confirming that a reservation for the selected activity has been made.

Clause 18. A search client according to clause 15, 16 or 17, wherein the plurality of activity managers comprises a sport center, a sport club or a healthcare provider and/or wherein the plurality of activities comprises sport and/or health related activities.

Clause 19. A computer program product stored on a non-transitory computer-readable medium, comprising instructions for causing a computer to execute the steps of, upon identification that search criteria for searching for an activity have been received: providing the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period; retrieving search results obtained, using a search tool, for said search criteria; outputting said search results using the input/output manager; receiving, via the input/output manager, selection input selecting an activity of the search results; and making, in the event that the selected activity is open for reservation, a reservation for the selected activity.

Clause 20. An infrastructure for storing activities to be searched and reserved, the infrastructure comprising: an activity repository, wherein the activity repository comprises: activity storage which stores activities provided by a plurality of activity managers, wherein an activity comprises an activity title, an activity location, and an activity time period, and activity storage logic arranged to manage operations on the activity storage; and a search tool, wherein the search tool comprises a search logic arranged to access the activity repository and to search for activities stored in the activity repository based on search criteria received from a search client, wherein said search criteria comprise a search description, a search location and a search time period and wherein the search tool returns search results obtained for said search criteria for the search client to provide to said user.

Clause 21. An infrastructure according to clause 20, wherein the plurality of activity managers comprises a sport center, a sport club or a healthcare provider and/or wherein the plurality of activities comprises sport and/or health related activities.

Clause 22. An infrastructure according to clause 21, wherein the search logic is arranged to search for activities matching the input search criteria based on an exact, approximate and/or fuzzy search algorithm.

Clause 23. An infrastructure according to clause 22, wherein the infrastructure further comprises a reporting unit and wherein: the reporting unit is arranged to receive and store selection information, the selection information identifying an activity selected, using the search client, from the search results and a corresponding user.

Clause 24. An infrastructure according to clause 23, wherein the reporting unit further comprises a report building unit and is further arranged to: receive, from an activity manager, activity attendance information wherein the attendance information is for the selected activity and the corresponding user; and build, using the report building unit, an attendance report for the corresponding user, the attendance report comprising activity attendance information for selected activities for said corresponding user.

Clause 25. A computer program product stored on a non-transitory computer-readable medium, comprising instructions for causing a computer to execute the steps of: storing, at an activity repository, activities provided by a plurality of activity managers, wherein an activity comprises an activity title, an activity location, and an activity time period; and searching, using a search tool, for activities stored in the activity repository based on search criteria received from a search client, wherein said search criteria comprise a search description, a search location and a search time period and wherein the search tool returns search results obtained for said search criteria for the search client to provide to said user.

Although the present disclosure, appended claims and above clauses set out particular feature combinations, the present disclosure also includes all other possible combinations of the features described herein, even where such combinations are not explicitly identified as such.

The techniques described herein may be implemented in hardware, software, firmware, or any combination thereof. Various features described as modules, units or components may be implemented together in an integrated logic device or separately as discrete but interoperable logic devices or other hardware devices. In some cases, various features of electronic circuitry may be implemented as one or more integrated circuit devices, such as an integrated circuit chip or chipset.

If implemented in hardware, this disclosure may be directed to an apparatus such a processor or an integrated circuit device, such as an integrated circuit chip or chipset. Alternatively or additionally, if implemented in software or firmware, the techniques may be realized at least in part by a computer readable data storage medium comprising instructions that, when executed, cause one or more processors to perform one or more of the methods described herein. For example, the computer-readable data storage medium or device may store such instructions for execution by a processor. Any combination of one or more computer-readable medium(s) may be utilized.

A computer-readable storage medium (device) may form part of a computer program product, which may include packaging materials. A computer-readable storage medium (device) may comprise a computer data storage medium such as random access memory (RAM), read-only memory (ROM), non-volatile random access memory (NVRAM), electrically erasable programmable read-only memory (EEPROM), flash memory, magnetic or optical data storage media, and the like. In general, a computer-readable storage medium may be any tangible medium that can contain or store a program for use by or in connection with an instruction execution system, apparatus, or device. Additional examples of computer readable medium include computer-readable storage devices, computer-readable memory, and tangible computer-readable medium. In some examples, an article of manufacture may comprise one or more computer-readable storage media.

In some examples, the computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

The code or instructions may be software and/or firmware executed by processing circuitry including one or more processors, such as one or more digital signal processors (DSPs), general purpose microprocessors, application-specific integrated circuits (ASICs), field-programmable gate arrays (FPGAs), or other equivalent integrated or discrete logic circuitry. Accordingly, the term “processor,” as used herein may refer to any of the foregoing structure or any other processing circuitry suitable for implementation of the techniques described herein. In addition, in some aspects, functionality described in this disclosure may be provided within software modules or hardware modules.

Although the examples and embodiments above have been described in considerable detail, numerous variations and modifications will become apparent to those skilled in the art once the above disclosure is fully appreciated. It is intended that the following claims be interpreted to embrace all such variations and modifications.

1. A method for finding and reserving activities, the method comprising:
receiving, at a search client, search criteria wherein the search criteria comprise a search description, a search location and a search time period;
providing the search criteria to a search tool;
searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers;
providing, using the search tool, the search results to the search client, the search results comprising activity data relating to at least one activity identified by the searching;
receiving, at the search client, selection input selecting an activity of the search results; and
making, in the event that the selected activity is open for reservation, a reservation for the selected activity.

2. A method according to claim 1 wherein the making a reservation comprises:
providing, from the search client to an activity manager, an activity reservation request for the activity selected by the selection input.

3. A method according to claim 2 wherein the making a reservation comprises:
receiving, at the search client, an activity reservation message confirming that a reservation for the selected activity has been made.

4. A method according to claim 1, the method further comprising:
providing, from a first activity manager, at least a first activity to the activity repository;
providing, from a second activity manager, at least a second activity to the activity repository;
storing, at the activity repository, the at least first and second activities.

5. A method according to claim 1, wherein the plurality of activity managers comprises a sport center, a sport club or a healthcare provider and/or wherein the plurality of activities comprises sport and/or health related activities.

6. A method according to claim 1 wherein a time period comprises at least one of a date, a time range, a starting time, a duration, an ending time and a repetition frequency.

7. A method according to claim 6 wherein a repetition frequency can be at least one of a daily, weekly, bimonthly, monthly, or yearly frequency.

8. A method according to claim 1, wherein searching for activities matching the input search criteria comprises searching based on an exact, approximate and/or fuzzy search algorithm.

9. A method according to claim 1, wherein the searching further or alternatively comprises searching for activities matching one or more criteria derived from a stored profile.

10. A method according to claim 1, wherein making a reservation for the selected activity comprises storing selection information, by a reporting unit, wherein the selection information identifies the selected activity and a corresponding user.

11. A method according to claim 10, the method further comprising:
communicating activity attendance information from an activity manager and to the reporting unit, wherein the attendance information is for the selected activity and the corresponding user; and
building, using the reporting unit, an attendance report for the corresponding user, the attendance report comprising activity attendance information for selected activities for said corresponding user.

12. A method according to claim 11, wherein the building of said attendance report comprises building the attendance report upon receipt of an attendance report request from an attendance supervisor and/or upon receipt of the activity attendance information.

13. A method for finding and reserving activities, the method comprising:
receiving, at a search client, search criteria wherein the search criteria comprise a search description, a search location and a search time period;
providing the search criteria to a search tool;
searching, using the search tool, for activities stored in an activity repository based on the search criteria wherein the activity repository stores, for each of a plurality of activities, an activity title, an activity location, and an activity time period and wherein activities stored in the activity repository have been provided by a plurality of activity managers;
providing, using the search tool, the search results to the search client, the search results comprising activity data relating to at least one activity identified by the searching;
receiving, at the search client, selection input selecting an activity of the search results; and
in the event that the selected activity is open for reservation:
making a reservation for the selected activity, making a reservation for the selected activity comprising storing selection information, by a reporting unit, wherein the selection information identifies the selected activity and a corresponding user;
communicating activity attendance information from an activity manager and to the reporting unit, wherein the attendance information is for the selected activity and the corresponding user; and
building, using the reporting unit, an attendance report for the corresponding user, the attendance report comprising activity attendance information for selected activities for said corresponding user.

14. A system for finding and reserving activities, the system comprising:
an activity repository, wherein the activity repository comprises:
activity storage which stores activities provided by a plurality of activity managers, wherein an activity comprises an activity title, an activity location, and an activity time period, and
activity storage logic arranged to manage operations on the activity storage;
a search tool, wherein the search tool comprises a search logic arranged to access the activity repository and to search for activities stored in the activity repository based on search criteria and wherein said search criteria comprise a search description, a search location and a search time period; and
a search client comprising
a search client logic, and
an input/output manager arranged to receive inputs from a user of the search client and to provide outputs to a user of the search client,
wherein the search client logic is arranged, upon identification that search criteria have been received via the input/output manager, to:
retrieve search results obtained, using the search tool, for said search criteria;
output said search results using the input/output manager;
receive selection input selecting an activity of the search results via the input/output manager; and
make, in the event that the selected activity is open for reservation, a reservation for the selected activity.

15. A search client for finding and reserving activities, the search client comprising:
a search client logic, and
an input/output manager arranged to receive inputs from a user of the search client and to provide outputs to a user of the search client,
wherein the search client logic is arranged, upon identification that search criteria for searching for an activity have been received via the input/output manager, to:
provide the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period;
retrieve search results obtained, using the search tool, for said search criteria;
output said search results using the input/output manager;
receive, via the input/output manager, selection input selecting an activity of the search results; and
make, in the event that the selected activity is open for reservation, a reservation for the selected activity.

16. A search client according to claim 15, wherein the search client logic being arranged to make a reservation comprises the search client logic being arranged to provide, to an activity manager, an activity reservation request for the activity selected by the selection input.

17. A search client according to claim 16 wherein the search client logic being arranged to make a reservation comprises the search client logic being arranged to receive an activity reservation message confirming that a reservation for the selected activity has been made.

18. A search client according to claim 15, wherein the plurality of activity managers comprises a sport center, a sport club or a healthcare provider and/or wherein the plurality of activities comprises sport and/or health related activities.

19. A computer program product stored on a non-transitory computer-readable medium, comprising instructions for causing a computer to execute the steps of, upon identification that search criteria for searching for an activity have been received:
providing the search criteria to a search tool, wherein said search criteria comprise a search description, a search location and a search time period, wherein the search tool comprises a search logic arranged to access the activity repository and to search for activities stored in the activity repository based on search criteria, and wherein an activity comprises an activity title, an activity location, and an activity time period
retrieving search results obtained, using a search tool, for said search criteria;
outputting said search results using the input/output manager;
receiving, via the input/output manager, selection input selecting an activity of the search results; and
making, in the event that the selected activity is open for reservation, a reservation for the selected activity.

20. An infrastructure for storing activities to be searched and reserved, the infrastructure comprising:
an activity repository, wherein the activity repository comprises:
activity storage which stores activities provided by a plurality of activity managers, wherein an activity comprises an activity title, an activity location, and an activity time period, and
activity storage logic arranged to manage operations on the activity storage; and
a search tool, wherein the search tool comprises a search logic arranged to access the activity repository and to search for activities stored in the activity repository based on search criteria received from a search client, wherein said search criteria comprise a search description, a search location and a search time period and wherein the search tool returns search results obtained for said search criteria for the search client to provide to said user.

21. An infrastructure according to claim 20, wherein the plurality of activity managers comprises a sport center, a sport club or a healthcare provider and/or wherein the plurality of activities comprises sport and/or health related activities.

22. An infrastructure according to claim 21, wherein the search logic is arranged to search for activities matching the input search criteria based on an exact, approximate and/or fuzzy search algorithm.

23. An infrastructure according to claim 22, wherein the infrastructure further comprises a reporting unit and wherein:
the reporting unit is arranged to receive and store selection information, the selection information identifying an activity selected, using the search client, from the search results and a corresponding user.

24. An infrastructure according to claim 23, wherein the reporting unit further comprises a report building unit and is further arranged to:
receive, from an activity manager, activity attendance information wherein the attendance information is for the selected activity and the corresponding user; and
build, using the report building unit, an attendance report for the corresponding user, the attendance report comprising activity attendance information for selected activities for said corresponding user.

25. A computer program product stored on a non-transitory computer-readable medium, comprising instructions for causing a computer to execute the steps of:
storing, at an activity repository, activities provided by a plurality of activity managers, wherein an activity comprises an activity title, an activity location, and an activity time period; and
searching, using a search tool, for activities stored in the activity repository based on search criteria received from a search client, wherein said search criteria comprise a search description, a search location and a search time period and wherein the search tool returns search results obtained for said search criteria for the search client to provide to said user.
